(19) United States
(12) Patent Application Publication
(10) Pub. No.: US 2006/0036544 A1
(43) Pub. Date: Feb. 16, 2006

(54) On-line payment method

(76) Inventor: Pal Dharam, Hyderabad (IN)

Correspondence Address: Bamesh Babu Vishwanath, #48 Srt 1st Floor, Prakash Nagar Bequmpet, Hyderabad Andhra Pradesh, 500016, IN

(21) Appl. No.: 10/530,668

(22) PCT Filed: Nov. 17, 2003
(86) PCT No.: PCT/IN03/00359

§ 371 Date: Apr. 8, 2005

(30) Foreign Application Priority Data
Nov. 18, 2002 (SG) 200206971-4

(51) Int. Cl. G06Q 40/00; G06Q 30/00

(52) U.S. Cl. 705/40; 705/26

(57) ABSTRACT

A payment System for online purchases that includes as participants a System Administrator, Members, Merchants and Subscribers/Non-Subscribers. Participating purchasers are Subscribers to a Member. Subscribers have pre-determined purchase limit and pre-determined delivery address for goods purchased within the System. Members may or may not be banking/financial institutions. Merchants charge the System Administrator for the value of all purchases made by subscribing purchasers. The System Administrator charges the Members to which purchasers subscribe for their purchases. System Administrator guarantees payment to Merchants. Members guarantee payment to the System Administrator. Members have their own commercial arrangement in place with their subscribing purchasers to recover money or moneys worth in exchange for the payments they make on behalf of Subscribers to the System Administrator. The System Administrator can be a Member too. The System Administrator may or may not be a financial institution. Non-Subscribers can also do online purchases by making up front payment to the System Administrator/Members to do online shopping on Merchant's site. For large value transactions where multiple signatories are involved the System adopts a unique authentication process to validate the USER ID and password of different signatories. No single server of System administrator shall hold all the signatories' login details. The System is applicable to b2c and/or b2b online payments. The System is applicable to online and/or offline transactions.

### FIELD OF INVENTION

The present invention relates to following:

An on-line payment method based upon its Subscribers' TOP ID*, fixed purchase limit, varying modes of sign-in information submission and authentication processes for purchase of goods and services over the Internet by consumers, businesses etc. The System is suitable for both low value and high value on-line transactions.

1. Background of the Invention

1. Internet seems to have come, and also stayed!, without making the desired impact on our lifestyle. I cannot make online payment from my Bank Account in Singapore to an online Merchant whose Bank Account is with a bank in Brazil. Reason, financial institutions banks are highly territorial and parochial when it comes to inter-bank/financial institution interaction.

2. It is due to concerns relating to privacy, security, regulatory frameworks in different countries and restrictive nature of various payment products. Lack of convergence of online processes and off-line processes has added to the difficulty. Hence, we have fragmented, insecure, compartmentalized online interfaces that give us lot of speed without the efficiency. The two most Vital aspects of electronic payments, a) fearlessness and b) seamlessness, remain elusive.

3. It is unlikely that the regulators/central bankers would, ever, come to an agreement that would help build a globally seamless online payment network. Though, currently online intra-bank payments are possible globally, but they are restricted to the same bank. In some pockets a few banks are forging alliance for this purpose and customers of those banks may be able to make payments to each other globally. But, that is still ‘only a few banks’ with limited geographical and customer coverage. A large number of banking/financial institutions, especially the ones located in the third world, may not be IT ready for y-e-a-r-s to come, to achieve the necessary integration to a global payment network. If ever there is one.

4. Only online payment product that is seamlessly global in its applicability is Credit Card.

* “TOP ID” is assigned by System Administrator to a Subscriber to the System. Underlying the TOP ID are all the memberships of a Subscriber with Members i.e. banks, credit card companies etc.

However, it lacks universality as its reach is limited by issuance eligibility criteria i.e. income limit, age limit etc. Hence, a 12 years old child, with money in his pocket cannot possibly have a Credit Card to play an online game against payment.

5. Another difficulty with online Credit Card payments is occurrence of frauds. Even for a purchase worth as little as a few dollars a Card holder exposes his entire Card limit, of several thousand dollars, to potential abuse. Empirical evidence suggests that the usage of Credit Cards online is fraught with frauds. The Credit Card fraud rate rises at a higher rate per annum then the online Credit Card usage rate!!!

Hence, current online payment systems are devoid of three most crucial aspects and they are 1) seamlessness, 2) fearlessness and 3) universality in terms of user base.

2. Description of the Prior Art

Low-Value Transactions:

1. Existing online payment gateways i.e. PayPal, c2it (now closed!), Certapay, WorldPay etc. ride directly (or in an umbrella format) on two main pillars, i.e. Credit Card and Bank Account, of the payment supply chain. In all these scenarios the online shopper needs to provide his personal financial details i.e. particulars relating to his Bank Account and/or Credit Card. Such details are to be provided either at the point of sale at Merchant's web site or prior to obtaining a ‘Common ID/password’ from these umbrella payment gateway providers. A Common ID/password issued under umbrella format is linked to one or more Bank Accounts/Credit Cards of that user.

2. At point of sale shopper gives away his Credit Card/Bank Account details or ‘Common ID/password’ even if the value of goods purchased is a mere fraction of either Credit Card limit(s) or the balance in a shopper's Bank Account(s). That leaves shopper's personal financial data or Common ID/password on merchant's server and with the employees of that merchant. In the case of Common ID/password the underlying Credit Card/Bank Account details reside with the payment gateway provider viz. PayPal. Merchant's server is relatively easy to hack. Anyone who hacks into merchant's server can play havoc with the shopper's residual Credit Card limit or Bank Account balance. Even an employee, apart from the hacker, of the said merchant can potentially carry out large fraudulent transactions with residual credit limit of a Credit Card or residual balance lying in a purchaser's Bank Account.

3. Umbrella formats make it that much more risky, because a hacker or an employee of a merchant can now play much greater havoc with a purchaser's multiple financial details that lie beneath the Common ID/password. Once a shopper's Common ID/password is known to an employee of the merchant or a hacker, he can use all the amount lying in that shopper's different Credit Cards/Bank Accounts the way he likes to. A consumer runs even greater risk under current umbrella format payment gateway providers.

4. Thus purchasers are concerned about providing their details over the Internet, both for security reasons and for reasons of confidentiality. Additionally, sellers are concerned about fraud fraud and non-payment of purchases. Payment solution providers and insurance companies get saddled with disowned online transactions and legal disputes.

*‘Common ID/password’ refers to ID/password given by current payment gateway providers to their subscribers for all their underlying Credit Card/Bank Accounts.

5. Hitherto, the effort by current online payment gateway providers is directed towards overcoming this problem from technology angle, by introducing higher and higher level of security i.e. VISA's 3D Secure. The war of wits between the technology developers and hackers is akin to one between police and thieves. Both keep acquiring more and more refined weapons and the crime rate does not fall. It is the same human mind that goes into programming and hacking both, after all! And it is likely, unfortunately, that fraud/abuse rate will keep moving up as time goes by. Thus, prospects of a robust growth in online transactions appear bleak.

6. Already, we have seen demise of several dotcom businesses with excellent business models. They could not be sustained as there was not a viable online payment mechanism that would bring shoppers to them without fear and seamlessly. Excessive, limitless and direct/indirect reliance on Credit Card/Bank Account of the shopper makes it difficult to come up with an online payment system that is without the security/fraud risks and is also globally seamless.

7. Thus, an on-line shopper cannot make payment from his small town without using the Credit Card. Besides, there are/can be only-so-many Credit Card holders in view of income and age limit criteria. No doubt Credit Card is the only seamlessly global payment product, but without the universal reach when it comes to its usage.

Large value online transactions:

1. B2B segment of online payments has to contend with similar difficulties, and more of them, at a greater and complex scale. These are big-ticket transactions, hence, there is greater requirement of security and more importantly of authentications, multiple authentications at that. Issue of seamlessness too glares at it as menacingly as in the case of low value online payments.

2. Once again various payment gateways that have come into being are either constrained by security concerns or are not seamless in terms of geographical reach. Besides, to render a user capable of making online payments a user is required to perform several ‘acts’, that are anything but user friendly, to execute an online payment. Thus, it makes the authentication process a bit too cumbersome to be used by an average user. Average user is average IT savvy and is, hitherto, used to making his payments offline. Hence, if he has to be moved to online platform he has to be given a very friendly, secure and seamless electronic alternative to do so.

3. Current solutions are also highly costly i.e. cost of the gadgets etc. and they require high level of logistic effort to get a user going on these platforms. A user needs to have various types of security/IT gadgets and also download some software. It is a logistical nightmare.

### SUMMARY OF TH INVENTION

1. It is an object of the present invention to provide a payment method for on-line purchases that alleviates, almost fully, most of the above-mentioned problems that impact current online payment systems at the same time making it totally hassle-free for Merchants and Subscribers to do online transactions.

Accordingly in one aspect of the present invention consists in a payment System* for online purchases which includes as participants, a System Administrator**, Merchants***, Membersˆ, Subscribersˆˆ and Non-Subscribersˆˆˆ, characterised in that; System Administrator administers the System, one set of participating purchasers are Subscribers to one or more Members, Another set of participating purchasers are Non-Subscribers (only for low value transactions) who purchase pre-paid perforated covers of various denominations containing a temporary user ID/password valid only for the given value, Merchants charge the System Administrator for the value of all purchases made by Subscribers/Non-Subscribers, the System Administrator charges the Members to which Subscribers subscribe for their purchases; the System Administrator need not be a financial institution i.e. bank/Credit Card company etc.; the System Administrator can be a Member/non-Member, Members have in place their own arrangements with their subscribing purchasers to recover money or moneys worth in exchange for the payments they make on behalf of Subscribers to the System Administrator,

2. Each Subscriber is assigned a TOP ID underlying which are his multiple affiliations with Members. Subscribers have a purchase limit, for online transactions within the System, assigned to them by the Member. Purchase limit is mutually agreed between the Subscriber and Member. A Subscriber can opt for as low an amount as possible as his limit. Hence, scope of fraudulent use of Subscriber's Bank Account/Credit Card balance is minimized.

* ‘System’ refers to proposed on-line payment method.

** ‘System Administrator/Administrator’ refers to an entity that shall administer the System; System Administrator need not be a bank/financial institution.

*** ‘Merchant or Merchants’ refers to sellers of goods and services, using System, online.

ˆ‘Member or Members’ refers to organisations (banking/financial and/or non-banking/non-financial) through whom the Subscribers shall subscribe to the System.

ˆˆ‘Subscriber or Subscribers’ refers to on-line shoppers/consumers who have opted to be part of the System through one or more Members.

ˆˆˆ‘Non-Subscriber(s)’ refers to those on-line shoppers/consumers who have opted not to be part of the System hut would like to shop on-line through the System as and when they like i.e. on one-off basis.

3. One application of the invention, for low value transactions, might be a transaction payment involving 1) a Bank Account holder, a 10 years old child, (as Subscriber) with online purchase limit of $100/- only, 2) bank (as Member), 3) Merchants and 4) System Administrator. Merchants and bank join the System, whereby the bank will pay the System Administrator for any purchases made by the Bank Account holder from Merchants. The bank's exposure is limited to a fixed amount per Bank Account holder. The bank may also opt to create a special escrow account scheme for the purpose in which case it will not even run any risk of uncovered exposure. The Merchant is paid by the Administrator for all purchases made under the System. The Administrator is paid by the bank for all purchases made by the Bank Account holder within, say, the following month.

4. The relationship between Subscriber and Member is such that the credit worthiness of the Subscriber is not an issue, thereby allowing even ‘traditionally’ non-credit worthy persons i.e. children, bankrupts, low-income earners etc. to make online purchases. A purchaser can either be a Subscriber to a Member or a Non-Subscriber. Subscribers need to have a relationship with the Member i.e. credit card company-Credit Card holder. Non-Subscriber can have a temporary/one-off arrangement with a Member, they are required to make upfront payment for the amount that they would need for online shopping.

5. For large value transactions, upon electing to make a purchase the Subscriber shall furnish his TOP ID on the Merchant's web site. Thereafter Merchant's server shall transmit the same with sales transaction reference number to System Administrator's server. Thereafter a new window, from System Administrator's server, carrying his TOP ID and sales transaction reference number, generated by Merchant's web site, shall prompt the Subscriber to key in his password, name etc. Subscriber shall key in his password, name etc. there and transmit the same to System Administrator's server. System Administrator's server shall thereafter check for validity of TOP ID, provided by Subscriber at Merchant's web site, and password, name etc. provided by Subscriber in the window popped out by System Administrator's server. System Administrator accordingly informs the Merchant's server whether the sales transaction is approved/not approved. Thus, a Subscriber does not provide all the sign-in information to the Merchant's server. Hence, Merchant's server or its employees do not have all the required personal sign-in information of a Subscriber. Hence, element of fraud is eliminated from online transaction to a great extent. In the case of multiple signatories for a Subscriber each signatory shall be assigned a separate TOP ID and password.

### BRIEF DESCRIPTION OF THE DRAWING

Preferred embodiments of the invention will now be described with reference to the accompanying drawing, in which:—

FIG. 1 is a flowchart showing Subscriber's low value transaction within the System

FIG. 2 is a flowchart showing Non-Subscriber's low value transaction within the System

FIG. 3 is a flowchart showing Subscriber's large value transaction authentication process within the System

### DESCRIPTION OF THE PREFERRED EMBODIMENTS

1. The present invention is an online System involving various categories of parties whom have joined up to the System: System Administrator, Members, Merchants and Subscribers/Non-Subscribers. Non-Subscribers join the System only for low value transactions on temporary/one-off basis. Integral to the System is an Administrator who controls and runs it. The Administrator may or may not be a bank/credit card company. The Administrator can also be a Member.

2. The main parties are the Merchants and Members. These are the parties who join the System through the Administrator and have an underlying commercial contract with the Administrator. The Merchants sell products or services to purchasers (Subscribers/Non-Subscribers) online and are paid by the Administrator. The Members pay the Administrator on behalf of their Subscribers. The Members collect payment from Subscribers affiliated to them for purchases made by them from the Merchants. The Merchants can also ride on the same System for their off-line sales where Subscriber can make payment at a Merchant's shop/store if said Merchant has a PC with Internet connection. Most of the Merchants today have that.

3. Members can be any category of organisation i.e. banks, credit card companies, telcos, ISPs, power supply companies, internet cafes, clubs, schools, employers etc. Effectively any organisation/individual that is in a position to guarantee payment to the System Administrator for purchases made by its Subscribers, from Merchants, can be a Member to the System. Moreover, Members could come into existence solely for the purpose of being Members of the System.

4. The Subscribers could be individuals or organisations of some sort. They can be Subscribers to one or more Members. As such, they are only party to the System through the Member, and not in their own right. Subscribers might be Bank Account holders, Credit Card holders, students, bankrupts, low-income earners, club members, employees etc.

5. A Subscriber can be associated with multiple Members at the same time. A Subscriber could opt for one single TOP ID/password for his multiple affiliations with different Members or a separate TOP ID/password for each Member. Each TOP ID/password shall carry a separate online shopping limit, tied to respective Member, in dollar terms. A Subscriber shall have different purchase limit from each member. If a Subscriber has one TOP ID/password for his multiple affiliations, to different Members, he will exercise the option, at the time of purchase, as to which particular Member he would like the purchase to be earmarked to.

6. There will be two categories of purchasers, a) Subscribers and b) Non-Subscribers. Subscriber category of purchasers, as explained above, shall be affiliated to one or more Members. They shall have their personal details registered within the System. All online purchases that need to be physically delivered shall be delivered, by default, to their pre-assigned mailing address. The Subscribers can, however, change the mailing address for a particular delivery by providing a higher level of password online. This eliminates, to a large extent, any misuse of the System by individuals who have, for some reason, come to acquire Subscribers' TOP ID/password.

7. The Non-Subscriber category of purchasers shall be those purchasers who are not affiliated to any of the Members by virtue of a prior relationship i.e. bank-account holder. They could however go to any of the Members and opt to obtain pre-paid perforated covers containing user ID/password allowing them to do online shopping for a specific amount at Merchant's web site on one-off basis. Non-Subscribers would usually carry out low value transactions.

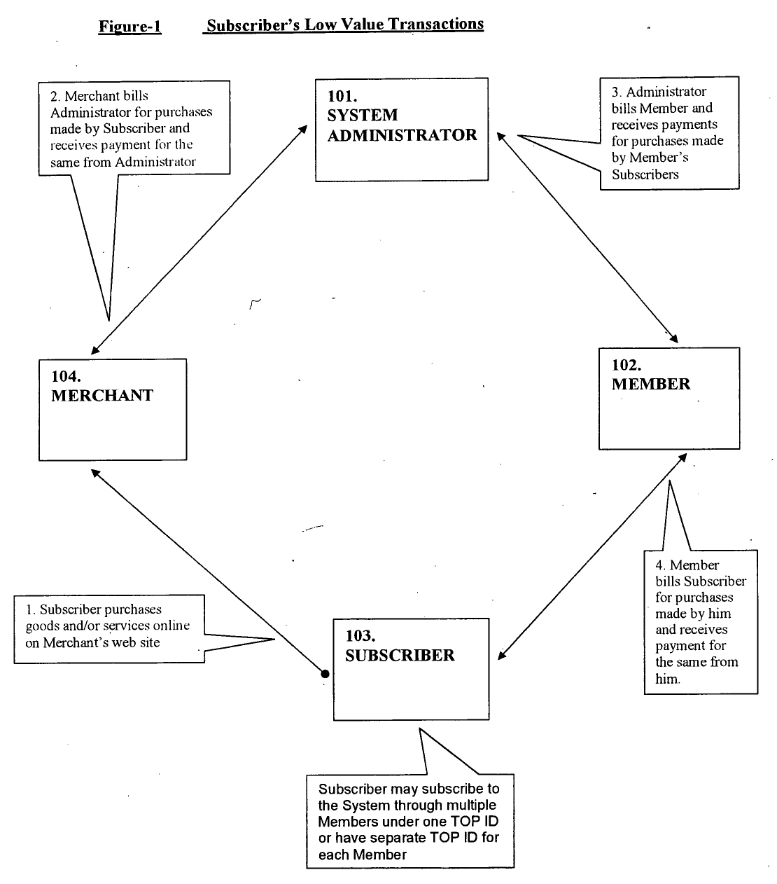

8. FIG. 1 diagrammatically illustrates the role of different participants within the System. The online payment System of the present invention is organised and controlled by an Administrator 101. The Administrator attracts Members 102 and Merchants 104 to the System. Merchants are attracted because the System has the potential to increase their online sales by facilitating sales to purchasers who may not otherwise be able to make purchases online. Proposed System not only eliminates/minimizes fraud risk but also has universal reach in terms of user base. This will go a long way in boosting a Merchant's online sales revenue.

9. In use a Subscriber 103 will visit the website of a Merchant 104 and place an order for goods and/or services sold by that Merchant. Merchants 104 deliver goods purchased online to Subscribers 103 via conventional means or electronically if the purchased items are digital in form. Although described in more detail later, three payment transactions are involved in this System. Merchants 104 will notify the Administrator of all purchases made on periodical basis. Administrator 101 will in turn notify respective Members 102 of purchases made by their respective Subscribers 103. Each Subscriber 103 will make a payment for his purchases to the Member 102 to which he subscribes. Members 102 will make a payment to the Administrator 101 for all purchases made by that Member's Subscribers. In turn Administrator 101 will make payments to Merchants 104 for all purchases made under the System by Subscribers.

10. Each Member and Merchant is issued a unique ID/password. The Administrator keeps a database of all the Merchants, Members and Subscribers. It also administers the Member, Merchant and Subscriber IDs. Each Member, Merchant and Subscriber shall be able to view his account status online within the System at System Administrator's master web site. Within the System, each Subscriber has his own purchase account with a credit limit. The accounts are also maintained by the Administrator in a database. The account is reset when the purchases are paid for by the Member and when the Member instructs the reset.

The mechanics of a typical purchase transaction will now be described:

11. A Subscriber 103 firstly visits a Merchant's website. He may opt to log on and identify that he belongs to a particular Member of the System, by entering his TOP ID. If the TOP ID is found valid, he will be able to find if there are specific promotions for that particular Member on the Merchant's site that entitles him to better terms of purchase. He may however opt not to log on at the start and do so only when he wishes to make a purchase.

12. Once the Subscriber wishes to finalise his purchase, he enters his TOP ID/password. The Merchant's server then checks with the Administrator's computer system to see if the TOP ID/password are valid. Additionally, the Administrator's system indicates if the Subscriber's System account credit limit has sufficient balance for the proposed purchase. If the purchase is validated by the Administrator's system, then the Subscriber's System account held in the system is updated with the purchase value, thus he cannot immediately over spend his limit with another purchase. The Merchant's site on receiving validation from the Administrator releases the goods or services and in the case of former arranges delivery to the Subscriber.

13. This System is not any more secure than current systems. It is open to as much fraud if a third party obtains a Subscriber's TOP ID/password. However, the uniqueness of the System lies in minimising the fraud by making the System a type of micro-payment System, limiting the amount any Subscriber can have outstanding at any one point of time. For instance, to $2,000/- or less. The purchase limit is determined by the Subscriber, in agreement with the Member, at the time of registration. The same is modifiable from time to time by the Subscriber subject to satisfactory compliance of Member's terms and conditions. As soon as a Subscriber makes a purchase, his account is updated. Once purchases accumulate to the Subscriber's account limit, further purchases are prevented or, if a purchase will take a Subscriber over the account's limits, then the Merchant will not receive a validation and the purchase is prevented. The Subscriber's accounts can only be reset upon the Subscriber's Member making payment to the Administrator. Thus fraudulent use is limited to $2,000/- or less per account. There could be Subscribers who may wish to have just $100/- as purchase limit. The $2,000/- figure is merely illustrative.

14. For a bogus purchaser, in possession of Subscribers' TOP ID/password, there is very little gain vis-à-vis the risk that he runs by carrying out his fraudulent transactions. Firstly, he must have several such IDs to achieve a respectable amount of fraud. Even with those IDs there is very little that he can achieve as physical delivery of goods, by default, shall be made to the pre-set address provided by the real Subscriber. This is second uniqueness of this System. A bogus purchaser, however, can purchase digital content etc. online. Again, how much of digital content he can download on one machine? And, how many machines he can have? For purchases limited in value this activity is hardly worthwhile.

If fraud does occur, it will usually come to light when a Subscriber denies a particular purchase. If this happens, the Subscriber's ID is immediately suspended from the System and investigations made. If it is only a mistake, then the account is reinstated. Where there is deemed to be fraud, the Administrator repays the Merchant, the Administrator may pay the Merchants directly. The Administrator keeps track and analyses fraud cases and claims, seeking to determine if particular Subscribers, Merchant or Members are more prone to fraud and, in some cases, even suspending or terminating the relevant Subscribers, Merchant, or Members from the System.

15. In the main embodiment, the only spending limits are imposed on the Subscribers. The Member's exposure is the total of the spending limits of all its Subscribers and each Member would typically be required to provide a bank guarantee or a matching cash deposit or any other assurance that is acceptable to the System Administrator for that sum. Subscribers can opt to have a shopping limit amount that is mutually agreeable to Subscriber and Merchant. However, Administrator shall have the final authority to allow a particular limit to a particular Subscriber.

16. It is up to the individual Members how and when they bill their Subscribers for purchases. Banks may do it by deducting the amount from account holder's account on monthly/fortnightly or any other frequency as agreed between the System Administrator and Member. In the case of Members who exist only for the purpose of being Members to the System, they may require payment up front for the whole of a Subscriber's credit limit. This would be especially true for Members whose Subscribers have no Bank Account/Credit Card or who are not affiliated to a school, employer, club etc.

17. Groups such as Internet cafes could own Subscriber IDs which they rent out to those wanting to use their machines. It is up to the Members how they obtain payment from Subscribers/Non-Subscribers. They may even charge for the service of providing access to the System. Internet cafes are likely to have large number of Non-Subscribing purchasers on temporary/one-off basis. Periodically Merchants 104 will supply purchase transaction details to the Administrator 101 for payment. The Administrator will pay the Merchants purchase value less a small percentage.

18. The System of the present invention has many advantages. For the Subscriber, he has little or no exposure to fraudulent use. Additionally, he does not have to provide personal details over the Internet. The only fields that he needs to fill in at Merchant's web site are TOP ID and a password for low value transactions. For large value transactions he merely needs to provide his TOP ID. He also'needs to provide a separate password if he desires that the goods to be delivered to an address different from the pre-set delivery address. Certainly, there is no need for him to disclose bunk details or Credit Card details over the Internet. Moreover; there is no need for a Subscriber to have specific hardware, such as card, a card reader thus there is no such thing as loss of card etc. All the logistical difficulties are removed from Subscriber and Merchant's end.

19. Costs to the Merchants under the System are likely to be substantially lower then what credit card companies charge them. This will be possible because there are a) no financing costs, b) low insurance premium due to reduced scope for fraudulent transactions, c) almost negligible amount of losses due to limited incentive for fraud and d) a good percentage of transactions is likely to take place on prepayment basis. The System Administrator's costs are primarily transaction processing costs and other administrative costs. The System Administrator also stands to benefit by carrying out treasury operations from the moneys collected from pre-payment basis transactions.

20. Purchasers are not so much worried about the cost of the goods online. They are more worried about the safety of their residual limit in their Credit Card and residual balance in their Bank Account. They are able to purchase merchandise online which is not available at their own location hence slight inflation in the price is tolerable for them. Merchants would not mind if the payment is received say a month later as long as they know that they will receive it for sure. They are more interested in achieving sales. Between high sales with payment one month later and low sales with immediate payment Merchants would rather prefer high sales with payment one month later.

21. An example of that would be buying expanded mail box from Yahoo! for $9.90 pa. Today even if a user wants to have a bigger e-mail box from Yahoo! he is hesitant to make payment via his Credit Card/Bank Account through current payment gateway providers as it would expose his residual amount to potential fraud, losses etc. As a result Yahoo! and the user both suffer. Under the proposed System Yahoo! may opt to charge $11/- instead of $9.90, user would be willing to pay $11/- as long as he knows that he is not subjecting his entire residual amount to potential fraud risk. Yahoo! would not mind receiving payment a month later as they have already increased the price by more than 10%.

22. Members to the System have different kinds of benefits depending upon their status. Banks get a huge cross selling opportunity to their existing account holders and also gain new customers by offering them internet shopping account (a dedicated account purely for online shopping). Credit card companies can ramp up their volumes as the volume of sales using them as Member would surge substantially. Schools, employers, clubs etc. can use this to provide it as a service or even make some money out of it. Stand alone Members who join the System for this purpose only, shall crop up almost everywhere as they will not only have substantial monetary benefits but they may also have several spin-off benefits as they would have built up a large base of captive users whom they can market other products and services.

23. The System is a closed community of shoppers, except for non-subscribing purchasers. A Merchant will be transacting with an identifiable customer. Customer relationships can begin to exist and grow. A Merchant can begin to recognise patterns from individual Subscribers and Members. The Administrator's database of Subscribers/Members and purchasing habits can provide analysable data for online shopping pattern for different demographics, social groups etc.

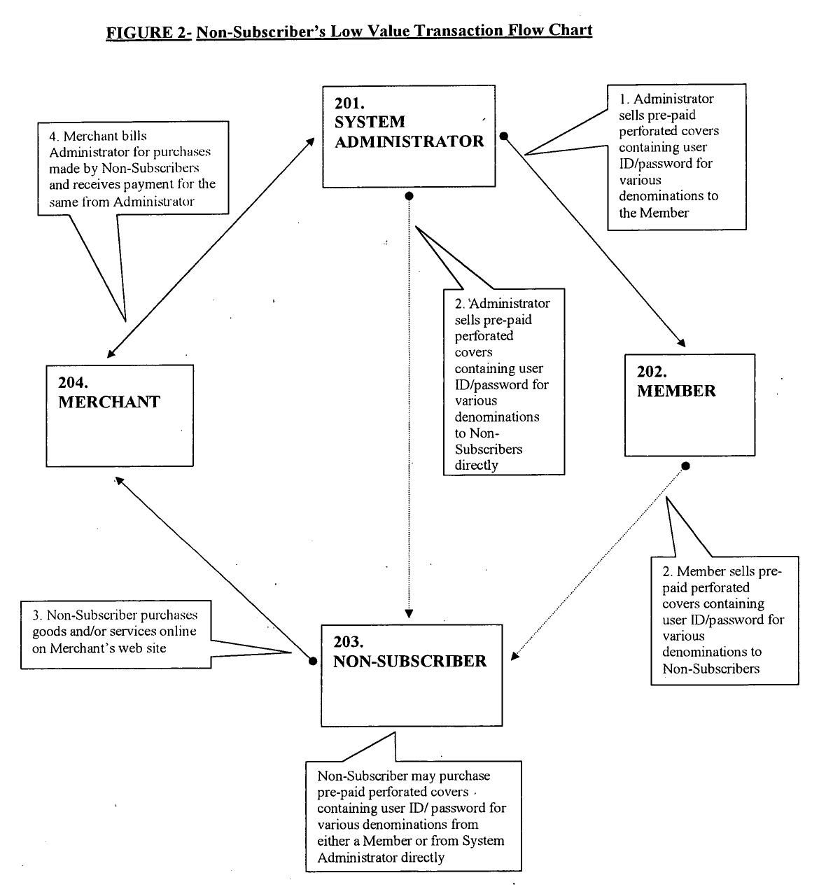

24. FIG. 2 diagrammatically illustrates low value transaction flowchart for Non-Subscribers 203. System Administrator 201 sells pre-paid perforated covers containing user ID/password of various denominations, usually not exceeding $2,000/-, to Members 202 or directly to the Non-Subscribers. Non-Subscribers can purchase the same from any of the Members or from the System Administrator. This would allow them to do online shopping up to that amount at Merchants' 204 web sites. Subscribers would visit Merchant's site, upon electing to purchase they would be prompted to key in TOP ID/password or user ID/password (for Non-Subscribers). They would then key in their user ID/password. They will also be required to provide delivery address if they have chosen to purchase goods that need to be delivered at a physical location. Thereafter the transaction approval process will be the same as for Subscribers. System Administrator shall make payment to Merchant without waiting to receive the same from Members as payment is already received by the System Administrator for Non-Subscribers.

25. Even Subscribers to the System may elect to be Non-Subscribers for certain type of transactions where they would like the goods to be delivered to an address other than pre-set delivery address i.e. a gift to someone. Such Subscribers may like to instruct the System Administrator, at the point of registration or at any other time later, that under no circumstances goods should be delivered to an address other than pre-set delivery address.

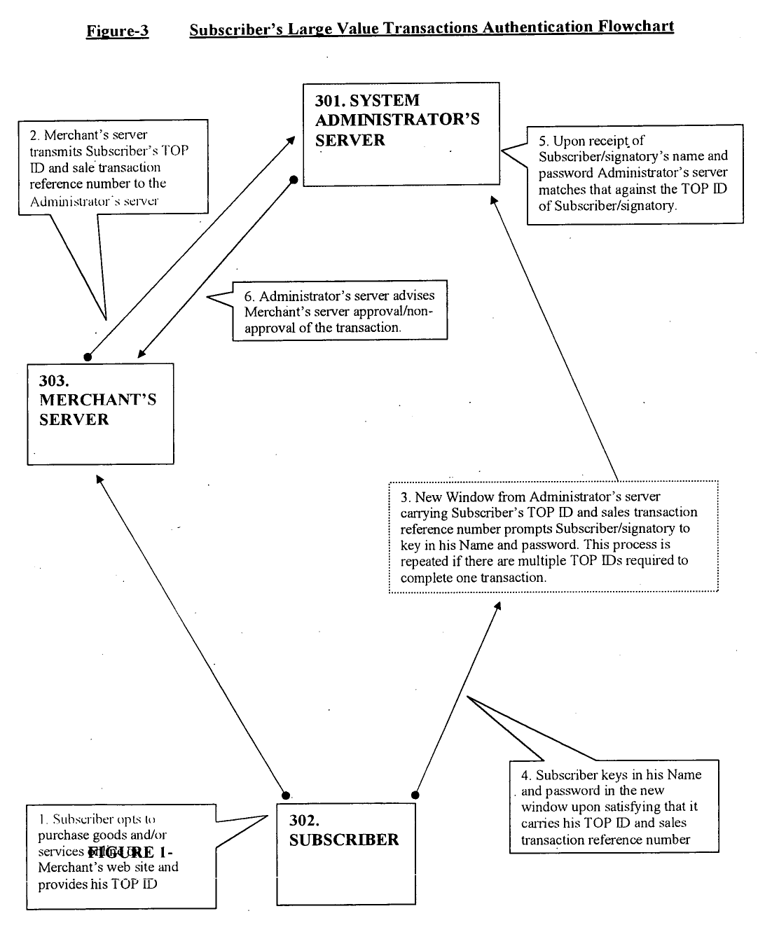

26. FIG. 3 diagrammatically illustrates the transaction authentication process for large value transactions. Subscribers 302 doing these transactions would usually be businesses. They may or may not have a purchase/payment limit within the System. They too join in through a Member. To complete a payment transaction they need to provide only their TOP ID at Merchant's site. They do not need to provide password, name etc. at Merchant's site. Thereafter Merchant's server 303 transmits the TOP ID along with sales transaction reference number for that particular purchase to System Administrator's server 301. Upon receipt of this information Administrator's server pops out a window carrying Subscriber's TOP ID and sales transaction reference number. It now prompts the Subscriber to key in his name, password etc. Subscriber satisfies that the window carries his TOP ID and sales transaction reference number; upon confirmation he keys in his name and password and transmits the same back to Administrator's server. Administrator's server checks the validity of TOP ID, name, password etc. Accordingly, it advises Merchant if the transaction is approved or not. If there are multiple signatories required for large value transactions a separate window from System Administrator's server pops out for each TOP ID and the relevant signatory needs to provide his name and password there and transmit the same back to Administrator's server for verification against the TOP ID already provided at Merchant's site. Thus a Subscriber is not required to provide all the sign-in information at Merchant's web site therefore it eliminates any possibility of a fraud.

27. In another scenario, for large value transactions, it is likely that one Subscriber makes payment to another Subscriber. In such scenario, paying Subscriber visits System Administrator's website, logs in with his TOP ID and password, etc. Then he identifies the other Subscriber whom he would like the payment to be made. He then keys in the amount that needs to be paid. For multiple signatories, relevant signatories key in their TOP ID/password to complete the payment transaction. Payment receiving Subscriber and Member concerned are advised immediately of the transaction.

28. For large value transactions the System provides for authentication of multiple signatories, to a Subscriber, for a particular transaction by System Administrator at its different servers. Thus, no single server at System Administrator's end or at Merchant's end has all the relevant sign-in information of all the signatories to a particular transaction by a Subscriber. Hence, it makes it almost fully secure and hacker proof. This may go a long way in may be doing away with other cumbersome security products i.e. smart card, tokens, PKI based systems etc.

29. It is an earnest objective of the proposed System to make online shopping totally hassle-free for the Merchant and Subscriber. By incorporating purchase limit and pre-set delivery address (for low value transaction Subscribers) and by incorporating a unique authentication process for multiple signatories (for large value transaction Subscribers) the proposed System hopes to achieve that. Parties to the System do not need to have any additional hardware or software.

30. A Subscriber could make payment from Administrator's web site in the similar manner to a Merchant too if there is no need of an underlying sales transaction or purchase. Merchant shall receive an instant advice from System Administrator's web site via e-mail etc. and the Merchant shall know who the paying Subscriber is. In this scenario, a Merchant can also be a Subscriber if he is affiliated to a Member to the System and can make payment to another Merchant.

31. Actual lead time for receipt of payment by payment receiving Subscriber or Merchant shall depend upon various Members' individual processes, location etc. System Administrator shall, however, guarantee the payment to payment receiving Subscriber or Merchant or Member. Further, System Administrator shall constantly endeavour to bring in uniformity in the lead time taken to make the payment available to payment receiving party by various Members. It is likely that in some instances, for expediency's sake, paying Subscriber's Member makes direct payment to the receiving Subscriber's Member/receiving Subscriber under advice to the System Administrator.

32. A Subscriber always has the option to notify a particular Member at the point of payment so that relevant Member is billed for that transaction by Administrator. Similarly, a Subscriber while making payment to another Subscriber can also notify receiving Subscriber's Member so that that Member eventually makes payment to the receiving Subscriber, upon receipt of payment from the Administrator/paying Subscriber's Member. A Merchant or Member can be a Subscriber too. The payment could be made from either Merchant's web site or from Administrator's web site to another Subscriber or to a Merchant.

33. The System thus provides total seamlessness and almost total fearlessness for online payments with universal reach in terms of user base. The System brings online shopping to everyone's doorstep irrespective of their age, income level, financial status, etc.

It is to be appreciated that the foregoing is illustrative and limiting of the invention, and that various changes and modifications described above will be apparent to those skilled in the art. Such changes and modifications can be made without departing from the spirit and scope of the present invention, and it is therefore intended that such changes and modifications be covered by the following claims:

1. An on-line payment System which includes as participants a System Administrator, Members, Merchants and Subscribers/Non-Subscribers (purchasers), characterised in that as a) System Administrator may or may not be a banking/financial institution; System Administrator guarantees payment to Merchants and charges the Members for purchases made by its Subscribers, b) One set of participating purchasers are Subscribers who subscribe to one or more Members, c) Another set of participating purchasers are Non-Subscribers who are not affiliated to any Member; they participate in the System by purchasing pre-paid perforated covers from a Member/Administrator containing user ID/password for a particular denomination; they would usually carryout low value transactions, d) Merchants are vendors of goods and services with an online store; they guarantee delivery of goods and/or services to purchaser (Subscribers) and charge the System Administrator for the value of all purchases made by Subscribers, e) Members may or may not be banking/financial institutions i.e. banks, credit card companies, schools, employers, clubs etc; Members guarantee payment to the System Administrator and have in place their own arrangements with their subscribing purchasers to recover money or moneys worth in exchange for the payments they make on behalf of Subscribers to the System Administrator, f) A Merchant can also be a Subscriber thus enabling him to make payment too, apart from receiving, to other Subscribers or Merchants,

2. A payment System for online purchases according to claim 1 wherein said System Administrator maintains a database of Subscribers, Members and Merchants, wherein each Subscriber is issued a System identifier (TOP ID) which is held by the Administrator and which must be provided along with password to Merchants, for low value transactions, when making a purchase and wherein during each online purchase transaction the Merchant forwards the Subscriber's TOP ID/password to the Administrator for validation and allows the purchase transaction to be concluded only if validation is received back from the Administrator.

3. A payment System for online purchases according to claim 2 wherein a purchase limit is set on the value of purchases a Subscriber may make, wherein during each online purchase transaction a) the Merchant additionally forwards the transaction value to the Administrator, b) Subscriber's purchase limit is determined by mutual agreement between a Subscriber and the Member, c) the Administrator checks that the total of the unpaid transactions in the account of that Subscriber (including the present transaction) does not exceed said limit, and if not, provides the Merchant with a further transaction validation allowing the purchase transaction to be concluded.

4. A payment System for online purchases according to claim 2 wherein the delivery address for the purchase of a Subscriber is preset and during each online purchase transaction where the Subscriber desires the delivery address to be other than the pre-set delivery address, the Subscriber provides to the Merchant an additional password, and the Merchant forwards the additional password to the Administrator for validation and the Merchant will despatch the goods to other than said pre-set delivery address only if validation is received back from the Administrator.

5. A payment system for online purchases which includes as participants a System Administrator, Member, Merchant and Subscribers/Non-Subscribers, comprising a) Merchant's web servers, each capable of accepting online purchase orders, b) internet devices to which all parties to the System have access, c) an Administrator server connected online which holds a database of Members and their Subscribers, d) said Merchant's web servers being programmed to transmit purchase charge data to said Administrator server after accepted purchase orders are made by a participating Subscriber, e) said Administrator's server being programmed to periodically send purchase charge data to Members in respect of purchasers who are Subscribers of those Members, f) and means enabling said Members to remit payment for said purchases to said Administrator.

6. A payment System for online purchases according to claim 5 wherein each subscribing purchaser has a System identifier (TOP ID), said Administrator's database stores Subscribers' TOP IDs and passwords, said Merchant's web server being programmed to interrogate said Administrator's server which is programmed to check its database for a match between the Subscriber entered TOP ID/password and the database and respond to said Merchant's server with a purchase validation message if a match is found, or respond with a purchase denied message if no match is found.

7. A payment System for online purchases according to claim 6 wherein said Administrator server is programmed to accumulate the value of each purchase made by a Subscriber held in the database and store the same in a Subscriber's account, a predetermined purchase value limit is stored for each Subscriber, and wherein the Administrator server is programmed to check the database to verify that the total of unpaid transactions in the account of that Subscriber (including the current transaction) does not exceed said limit, and if not, to transmit to the Merchant's server a validation message enabling the purchase transaction to be concluded, and if said limit is exceeded to transmit to the vendor server a purchase denied message.

8. A payment System for online purchases according to claims 6 and 7 wherein said Administrator database stores Subscribers' preset delivery address and a change of delivery address additional passwords, said Merchant's web server is programmed to receive a purported change of delivery address additional password, interrogate said Administrator's server, and said Administrator server is programmed to check its database for a match between said purported change of delivery address additional password and the additional password in said database and respond to said Merchant server with a change of delivery address validation message if a match is found or respond with a change of delivery address denied message of no match found.

9. A payment System for online purchases according to claim 1 and claim 5 wherein for large value transactions a Subscriber nominates various signatories with varying signing power amounts and also designates combinations of signatories that are required to complete a particular online payment transaction within the System. The said System Administrator maintains a database of Subscribers' multiple signatories, their various combinations thereof, for large value transactions, wherein each signatory of the Subscriber has a System identifier (TOP ID), signing power amount, password, name etc.

10. A payment System for online purchases according to claim 9 wherein for large value transactions a Subscriber upon electing to purchase or to make payment to another Subscriber/Merchant shall provide one or more of his signatories' TOP ID, in conformity with predetermined signing arrangement, at Merchant's web site. Each signatory to the Subscriber shall do so separately if multiple signatories are required to complete the transaction, thereafter Merchant shall forward the TOP ID and a sales transaction reference number to Administrator's server; thereafter Administrator's server shall pop out a new window carrying that signatory's TOP ID and sales transaction reference number, the window shall prompt the signatory to provide his password and name etc. Upon receipt of said information from signatory/signatories, Administrator's server matches the information with the information in its database and advises accordingly to the Merchant whether the transaction is approved or not approved.

11. A payment System for online purchases according to claim 10 wherein there are multiple signatories to a large value transaction the System Administrator shall use different servers for authenticating different level of signatories to a Subscriber; for instance A level signatory's sign-in information is received and authenticated at server A and B level signatory's sign-in information is received and authenticated at server B and so forth; each of these servers separately conveys to the Merchant's server about approval or non-approval of that particular signatory's sign-in; thus making it almost fully hacker proof at System Administrator's end as no single server would have the sign-in information for all the signatories to a particular payment transaction of a Subscriber.

12. A payment System for online purchases according to claim 1, claim 2, claim 5 and claim 9 wherein Subscriber and its signatory/signatories shall be able to make online payment to other Subscriber and Merchants from System Administrator's web site also in circumstances where they do not need to provide underlying sales transaction reference number or there is no underlying purchase by Subscribers.

13. A payment System according to claim 12 wherein Subscribers/Non-Subscribers to the System shall be able to make payment to a Merchant for their off-line purchases too, provided the Merchant makes available internet access to the shopper at its store.
